(19) United States
(12) Patent Application Publication
(10) Pub. No.: US 2020/0273401 A1
(43) Pub. Date: Aug. 27, 2020

(54) DISPLAYING APPARATUS FOR SCANNING FINGERPRINT AND METHOD THEREOF

(71) Applicant: INT TECH CO., LTD., HSINCHU COUNTY (TW)

(72) Inventor: SHIN-SHIAN LEE, HSINCHU CITY (TW)

(21) Appl. No.: 16/281,586

(22) Filed: Feb. 21, 2019

(51) Int. Cl. G09G 3/3233; G06K 9/00; G06F 3/0488; G06F 3/041

(52) U.S. Cl. CPC G09G 3/3233; G06F 3/0416; G06F 3/04886; G06K 9/0004

(57) ABSTRACT

A circuit includes: a panel; a first driving device, disposed on an upper side of the panel, for driving a first display portion of the panel; a second driving device, disposed on a lower side of the panel, for driving a second display portion of the panel; and a control device, coupled to the first driving device and the second driving device, for controlling one of the first driving device and the second driving device to scan a fingerprint on one of the first display portion and the second display portion respectively.

### BACKGROUND

Fingerprint sensing is a reliable and widely used technique for personal identification or verification in mobile devices. Normally, in a mobile device, a fingerprint sensor is formed on the lower portion nearby the display panel, and such design may sacrifice the area of the display panel. Moreover, some users may not he intuitively touch the fingerprint sensor when the fingerprint sensor is fixed on the lower portion of the mobile device. Therefore, there is a need to provide a novel fingerprint sensing system on the mobile device to solve the above mentioned problems.

### SUMMARY

Embodiments of the present invention provide a displaying apparatus. The displaying apparatus comprises a panel, a first driving device, a second driving device, and a control device. The first driving device is disposed on an upper side of the panel for driving a first display portion of the panel. The second driving device is disposed on a lower side of the panel for driving a second display portion of the panel. The control device is coupled to the first driving device and the second driving device for controlling one of the first driving device and the second driving device to scan a fingerprint on one of the first display portion and the second display portion respectively.

In one embodiment, the first display portion and the second display portion are different portions on the panel.

In one embodiment, the first driving device and the second driving device are separated driving devices on the upper side and the lower side of the panel respectively.

In one embodiment, the area of the first display portion is a first area, the area of the second display portion is a second area, and the first area is greater than the second area.

In one embodiment, the first driving device and the second driving device are arranged to scan the first display portion and the second display portion by a first frame rate during a first operating mode of the panel, and the second driving device is arranged to scan the second display portion by a second frame rate during a second operating mode of the panel, and the second frame rate is higher than the first frame rate.

In one embodiment, the first driving device is disabled during the second operating mode.

In one embodiment, the first display portion and the second display portion are arranged to detect a touch signal during the first operating mode, and the second display portion is arranged to detect the fingerprint during the second operating mode.

In one embodiment, the first display portion is arranged to not detect the touch signal during the second operating mode.

In one embodiment, during the first operating mode, the control device controls the first driving device to scan the first display portion and to control the second driving device to scan the second display portion after the first display portion is scanned.

Embodiments of the present invention provide a displaying apparatus. The displaying apparatus comprises a panel, a plurality of driving devices, and a control device. The plurality of driving devices is disposed in sequence from an upper side of the panel to a lower side of the panel for driving a plurality of display portions of the panel respectively. The control device is coupled to the plurality driving devices for selecting one of the plurality driving devices to scan a fingerprint on the panel according to a position of the fingerprint.

In one embodiment, the plurality of display portions are different portions on the panel.

In one embodiment, the plurality of driving devices are separated driving devices disposed from the upper side to the lower side of the panel.

In one embodiment, the plurality of display portions are configured to have a same area.

In one embodiment, the control device further determines a specific display portion in the plurality of portions according to a finger position on the panel, and the control device further controls a specific driving device in the plurality of driving devices to scan the fingerprint on the specific display portion, and the specific display portion corresponds to the specific driving device.

In one embodiment, the control device further controls the plurality of display portions other than the specific display portion to stop detect a touch signal when the specific driving device scans the fingerprint on the specific display portion.

In one embodiment, during a first operating mode, the control circuit controls the plurality of driving devices to sequentially scan the plurality of display portions according to a first frame rate; during a second operating mode, the control circuit controls a specific driving device in the plurality of driving devices to scan the finger print in a specific display portion in the plurality of display portions according to a second frame rate; and the second frame rate is higher than the first frame rate.

Embodiments of the present invention provide a method of controlling a displaying apparatus. The displaying apparatus comprises: a panel, having a plurality of display portions; and a plurality of driving devices, disposed in sequence from an upper side to a lower side of the panel. The method comprises: determining a specific display portion in the plurality of display portions according to a finger position on the panel; and controlling a specific driving device in the plurality of driving devices to scan a fingerprint on the specific display portion; wherein the specific display portion corresponds to the specific driving device.

In one embodiment, the method further comprises: detecting the finger position on the panel.

In one embodiment, the method further comprises: controlling other driving devices in the plurality of driving devices to stop detect a touch signal on the plurality of display portions other than the specific display portion when the specific driving device scans the fingerprint on the specific display portion.

In one embodiment, the method further comprises: during a first operating mode, controlling the plurality of driving devices to sequentially scan the plurality of display portions according to a first frame rate; and during a second operating mode, controlling the specific driving device in the plurality of driving devices to scan the fingerprint in the specific display portion in the plurality of display portions according to a second frame rate; and the second frame is higher than the first frame rate.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram illustrating a displaying apparatus in accordance with some embodiments of the present invention.

FIG. 2 is a diagram illustrating a mobile device having a displaying apparatus during a first operating mode in accordance with some embodiments.

FIG. 3 is a diagram illustrating a mobile device having a displaying apparatus during a second operating mode in accordance with some embodiments.

FIG. 4 is a diagram illustrating a displaying apparatus in accordance with some embodiments of the present invention.

FIG. 5 is a timing diagram illustrating a first control signal and a second control signal during a first operating mode in accordance with some embodiments.

FIG. 6 is a timing diagram illustrating a first control signal and a second control signal during a second operating mode in accordance with some embodiments.

FIG. 7 is a diagram illustrating a displaying apparatus in accordance with some embodiments of the present invention.

FIG. 8 is a flowchart illustrating a method of controlling a displaying apparatus in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

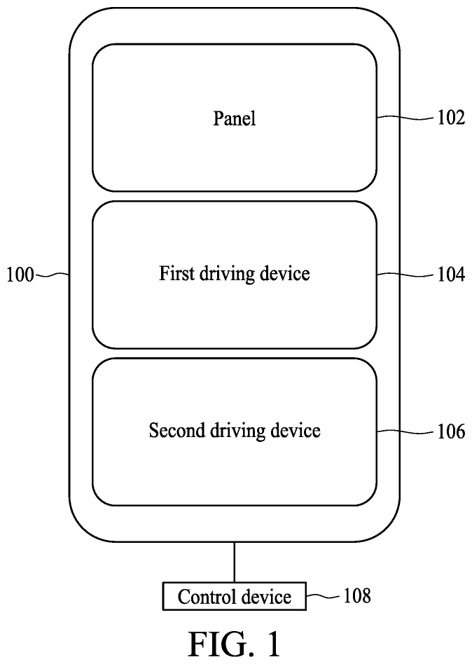

FIG. 1 is a block diagram illustrating a displaying apparatus 100 in accordance with some embodiments of the present invention. The displaying apparatus 100 may be formed in a mobile device. The displaying apparatus 100 comprises a panel 102, a first driving device 104, a second driving device 106, and a control device 108. The panel 102 may be a display panel capable of displaying images and detecting touch signals thereon. Moreover, the panel 102 is further configured to detect a fingerprint touching on a specific display portion of the panel 102. The first driving device 104 is disposed on a first side of the panel 102 for driving a first display portion of the panel 102. The second driving device 106 is disposed on a second side of the panel 102 for driving a second display portion of the panel 102. The control device 108 is coupled to the first driving device 104 and the second driving device 106. The control device 108 is arranged to individually control the first driving device 104 and the second driving device 106 to drive the first display portion and the second display portion respectively. According to some embodiments, the first display portion and the second display portion are different portions on the panel 102. For example, the first display portion may be the upper portion of the panel 102 and the second display portion may be the lower portion of the panel 102. Moreover, the area of the first display portion is a first area, the area of the second display portion is a second area, and the first area is greater than the second area.

According to some embodiments, the control device 108 may control the displaying apparatus 100 to operate under a first operating mode and a second operating mode. During the first operating mode, the panel 102 is arranged to display images and detect touch signals on the panel 102. During the second operating mode, the panel 102 is arranged to detect the fingerprint on the panel 102. According to some embodiments, the first driving device 104 and the second driving device 106 are enabled during the first operating mode, and the first driving device 104 may be disabled and the second driving device 106 is enabled during the second operating mode.

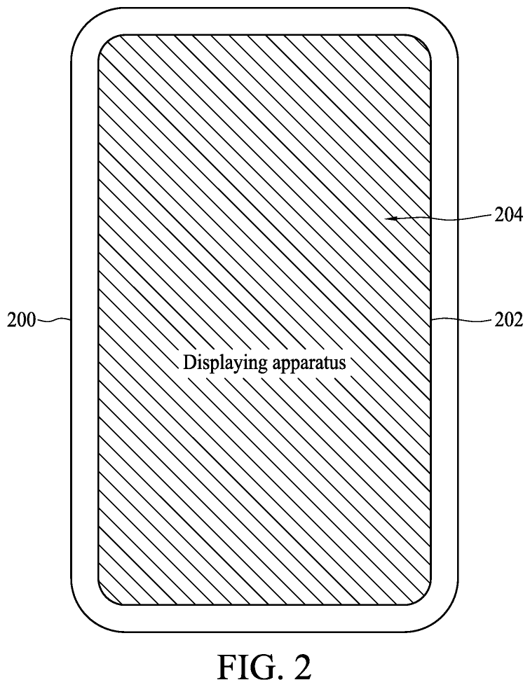

FIG. 2 is a diagram illustrating a mobile device 200 having a displaying apparatus 202 operated under the first operating mode in accordance with some embodiments. During the first operating mode, the whole panel 204 is configured to display images and to detect the touch signals on the panel 204.

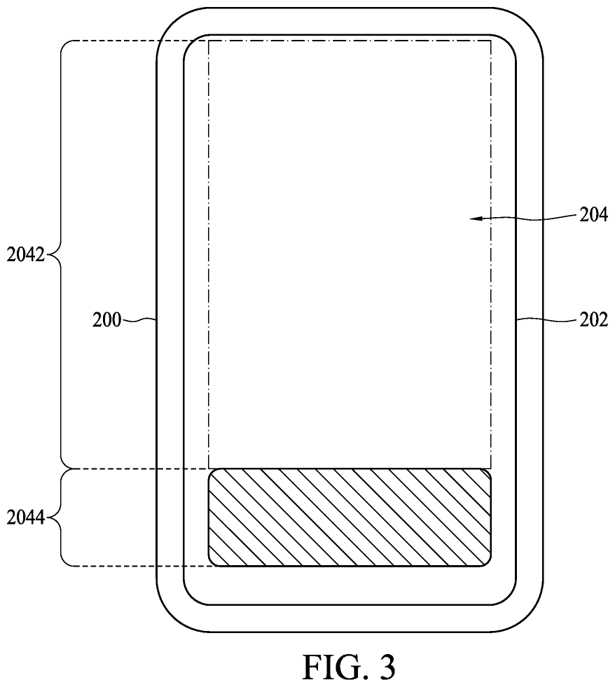

FIG. 3 is a diagram illustrating the mobile device 200 having the displaying apparatus 202 operated under the second operating mode in accordance with some embodiments. During the second operating mode, only the lower portion 2044 of the panel 204 is arranged to detect the fingerprint on the lower panel 2044, and the upper portion 2042 of the panel 204 is arranged to not detect touch signals on the upper portion 2042. According to some embodiments, during the second operating mode, the upper portion 2042 of the panel 204 may be controlled to operate under the power saving mode or the verification mode. During the power saving mode, the upper portion 2042 of the panel 204 may be an irresponsive dark screen. During the verification mode, the upper portion 2042 of the panel 204 may be irresponsive until the fingerprint is verified and validated.

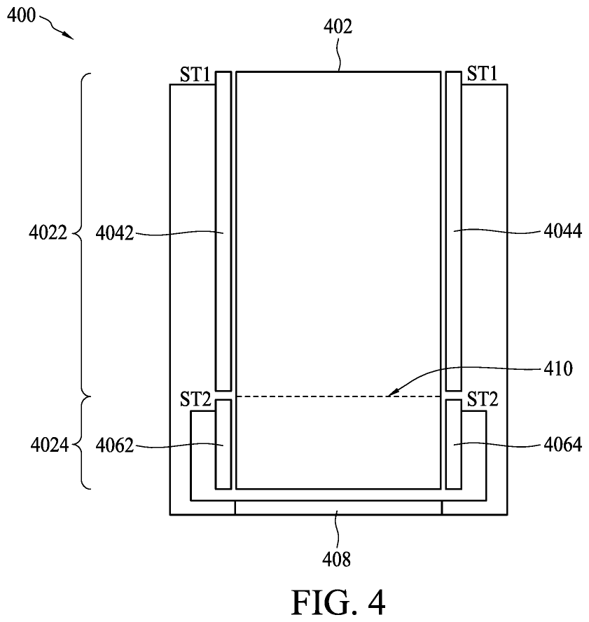

FIG. 4 is a diagram illustrating a displaying apparatus 400 in accordance with some embodiments of the present invention. The displaying apparatus 400 comprises a panel 402, a first upper driving device 4042, a second upper driving device 4044, a first lower driving device 4062, a second lower driving device 4064, and a control device 408. The control device 408 is coupled to the first upper driving device 4042, the second upper driving device 4044, the first lower driving device 4062, and the second lower driving device 4064. The first upper driving device 4042 and the second upper driving device 4044 are arranged to drive the upper display portion 4022 of the panel 402. The first lower driving device 4062 and the second upper driving device 4064 are arranged to drive the lower display portion 4024 of the panel 402. It is noted that the dashed line 410 is used for illustrating the upper display portion 4022 and the lower display portion 4024 of the panel 402, and the dashed line 410 may not be a real line in the panel 402.

According to some embodiments, the first upper driving device 4042, the second upper driving device 4044, the first lower driving device 4062, and the second lower driving device 4064 are gate driving circuits. The first upper driving device 4042 is disposed on the upper left side of the panel 402 and the second upper driving device 4044 is disposed on the upper right side of the panel 402. The first lower driving device 4062 is disposed on the lower left side of the panel 402 and the second lower driving device 4064 is disposed on the lower right side of the panel 402. Moreover, the first upper driving device 4042 is physically separated from the first lower driving device 4062 on the left side of the panel 402, and the second upper driving device 4044 is physically separated from the second lower driving device 4064 on the right side of the panel 402.

According to some embodiments, the control device 408 may control the displaying apparatus 400 to operate under a first operating mode and a second operating mode. During the first operating mode, the upper display portion 4022 and the lower display portion 4024 of the panel 402 are arranged to display images and detect touch signals on the panel 402. Durin.g the second operating mode, the lower display portion 4024 of the panel 402 is arranged to detect the fingerprint. According to some embodiments, the upper driving devices 4042, 4044, and the lower driving devices 4062, 4064 are enabled during the first operating mode. The upper driving devices 4042 and 4044 may be disabled and the lower driving devices 4062 and 4064 are enabled during the second operating mode.

In addition, during the first operating mode, the control device 408 is arranged to control the first upper driving device 4042, the second upper driving device 4044, the first lower driving device 4062, and the second lower driving device 4064 to scan the panel 402 by a first frame rate. For example, the first frame rate may be 60 fps (Frame per Second). According to some embodiments, the control device 408 may first generate a first control signal ST1 to control the first upper driving device 4042 and the second upper driving device 4044 to scan the upper display portion 4022 by the first frame rate. Then, after the upper display portion 4022 is scanned by the first upper driving device 4042 and the second upper driving device 4044, the control device 408 may generate a second control signal ST2 to control the first lower driving device 4062 and the second lower driving device 4064 to scan the lower display portion 4024 by the first frame rate.

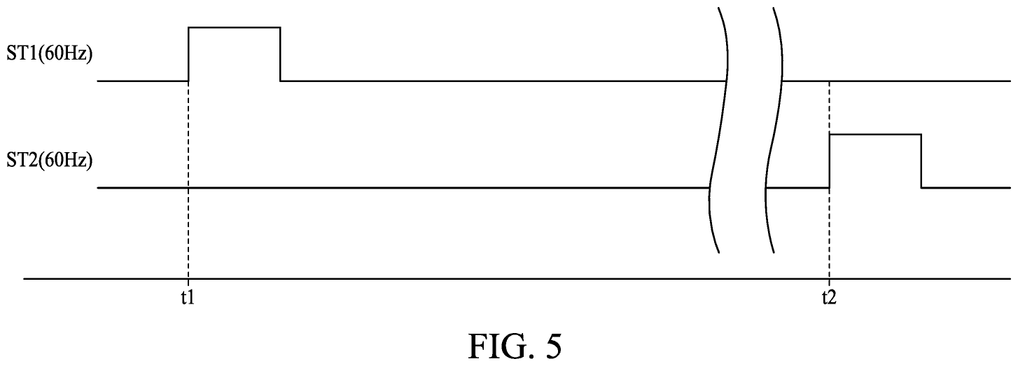

FIG. 5 is a timing diagram illustrating the first control signal ST1 and the second control signal ST2 during the first operating mode in accordance with some embodiments. The first control signal ST1 may be generated at time t1, and the second control signal ST2 may be generated at time t2 that is later than time t1. According to some embodiments, the first control signal ST1 may be the activation signal of the first upper driving device 4042 and the second upper driving device 4044, and the second control signal ST2 may be the activation signal of the first lower driving device 4062 and the second lower driving device 4064. Moreover the frequencies of the first control signal ST1 and the second control signal ST2 may be 60 Hz when the first frame rate is 60 fps. For example, at time t1, the control device 408 activates the upper display portion 4022 and the second upper driving device 4044 scan 60 frames of the upper display portion 4022 in a period (e.g. 1/60 Hz). Then, at time t2, the control device 408 activates the first lower driving device 4062 and the second lower driving device 4064 to scan 60 frames of the lower display portion 4024 in a period (e.g. 1/60 Hz). Then, the frames of the upper display portion 4022 and the lower display portion 4024 are combined to form the frames of the panel 402.

During the second operating mode, the control device 408 is arranged to activate the first lower driving device 4062 and the second lower driving device 4064 to scan the lower display portion 4024 of the panel 402 by a second frame rate. During the second operating mode, the first upper driving device 4042 and the second lower driving device 4044 are inactivated. For example, the second frame rate may be 240 fps (Frame per Second). According to some embodiments, the control device 408 may generate the second control signal ST2 with 240 Hz to control the first upper driving device 4042 and the second upper driving device 4044 to scan the low display portion 4024 by the second frame rate. When the frame rate on the lower display portion 4024 is increased, the resolution of the fingerprint attached on the lower display portion 4024 is increased, and the identification accuracy of the fingerprint is also increased.

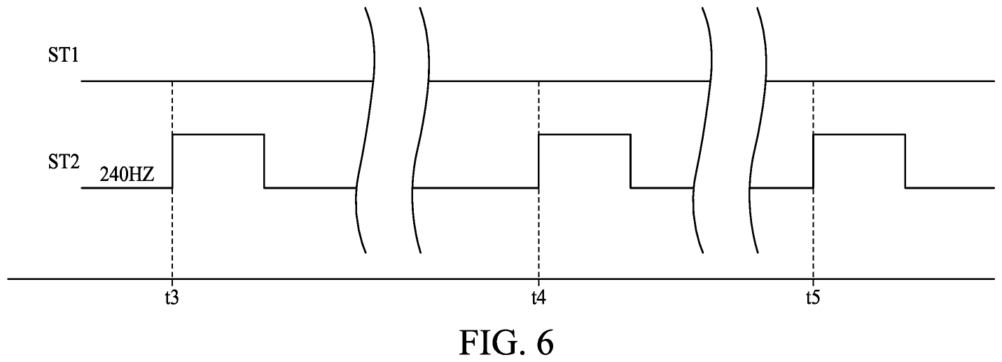

FIG. 6 is a timing diagram illustrating the first control signal ST1 and the second control signal ST2 during the second operating mode in accordance with some embodiments. According to some embodiments, the first control signal ST1 remains at low voltage level, i.e. inactive. The second control signal ST2 may actives the first lower driving device 4062 and the second lower driving device 4064 to scan the lower display portion 4024 at times t3, t4, and t5. The frequency of the second control signal ST2 may be 240 Hz when the second frame rate is 240 fps.

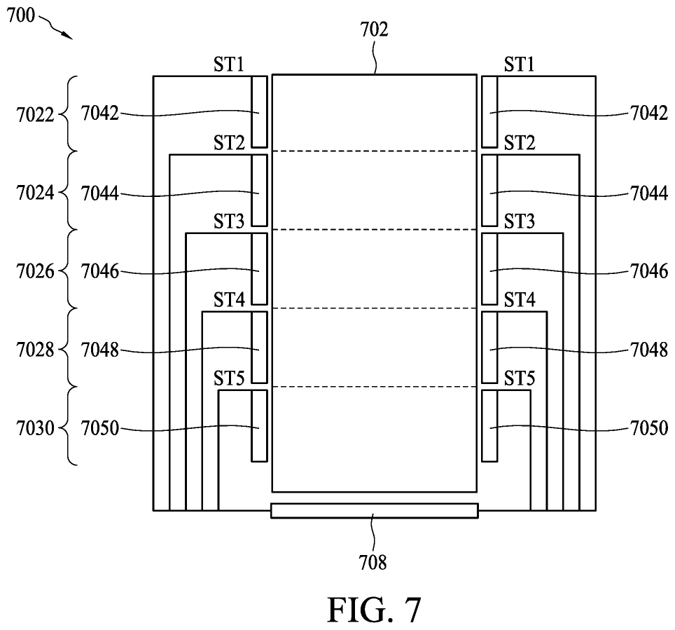

FIG. 7 is a diagram illustrating a displaying apparatus 700 in accordance with some embodiments of the present invention. The displaying apparatus 700 comprises a panel 702, a plurality of driving devices 7042, 7044, 7046, 7048, and 7050, and a control device 708. The driving devices 7042, 7044, 7046, 7048, and 7050 are disposed in sequence from upper side of the panel 702 to lower side of the panel 702. Each of the driving devices 7042, 7044, 7046, 7048, and 7050 comprises a pair of driving circuits, wherein one driving circuit is disposed on the left side of the panel 702 and the other driving circuit is disposed on the right side of the panel 702. The control device 708 is coupled to the driving devices 7042, 7044, 7046, 7048, and 7050. The driving devices 7042, 7044, 7046, 7048, and 7050 are arranged to drive the display portions 7022, 7024, 7026, 7028, and 7030 of the panel 702 respectively. It is rioted that the dashed lines shown in the panel 702 is used for illustrating the different display portions of the panel 702, and the dashed lines may not be a real line in the panel 702.

According to some embodiments, the driving devices 7042, 7044, 7046, 7048, and 7050 are gate driving circuits. The driving devices 7042, 7044, 7046, 7048, and 7050 are physically separated from each other on both sides of the panel 702.

According to some embodiments, the control device 708 may control the displaying apparatus 700 to operate under a first operating mode and a second operating mode. During the first operating mode, the display portions 7022, 7024, 7026, 7028, and 7030 are arranged to display images and detect touch signals on the panel 702. During the second operating mode, one of the display portions 7022, 7024, 7026. 7028, and 7030 is selected to detect the fingerprint. According to some embodiments, the display portions 7022, 7024, 7026, 7028, and 7030 during the first operating mode. During the second operating mode, the selected driving device (e.g. 7048) is enabled, and the rest of the driving devices (e.g. 7042, 7044, 7046, and 7050) are disabled.

During the first operating mode, the control device 708 is arranged to control the driving devices 7042, 7044, 7046, 7048, and 7050 to sequentially scan the display portions 7022, 7024, 7026, 7028, and 7030 by a first frame rate, For example, the first frame rate may be 60 fps (Frame per Second). According to some embodiments, the control device 708 may first generate a first control signal ST1 to control the first driving device 7042 to scan the first display portion 7022 by the first frame rate. Then, after the display portion 7022 is scanned by the first driving device 7042, the control device 708 may generate a second control signal ST2 to control the second driving device 7044 to scan the second display portion 7024 by the first frame rate. Then, after the display portion 7024 is scanned by the second driving device 7044, the control device 708 may generate a third control signal ST3 to control the third driving device 7046 to scan the third display portion 7026 by the first frame rate. Then, after the display portion 7026 is scanned by the third driving device 7046, the control device 708 may generate a fourth control signal ST4 to control the fourth driving device 7048 to scan the fourth display portion 7028 by the first frame rate. Then, after the display portion 7026 is scanned by the fourth driving device 7048, the control device 708 may generate a fifth control signal ST5 to control the fifth driving device 7050 to scan the fifth display portion 7030 by the first frame rate. The frequencies of the control signals ST1, ST2, ST3, ST4, and ST5 may be 60 Hz when the first frame rate is 60 fps. Then, the frames of the display portions 7022, 7024, 7026, 7028, and 7030 are combined to form the frames of the panel 702. The operation of the first operating mode of the displaying apparatus 700 is similar to the operation of the first operating mode of the displaying apparatus 400, and the detailed is omitted here for brevity.

During the second operating mode, the control device 708 is arranged to detect the position of a finger touched on the panel 702. Then, the control device 708 selects the display portion touched by the finger to be the specific display portion used for scanning the fingerprint of the finger. The control device 708 may control the driving device corresponding to the specific display portion to scan the fingerprint by the second frame rate. During the second operating mode, the control device 708 may disable the driving devices other than the specific driving device such that the driving devices do not affect the scanning operation of the specific driving device. In other words, the control device 708 may control the driving devices other than the specific driving device to stop detect the touch signals on the display portions when the specific driving device scans the fingerprint on the specific display portion. For example, during the second operating mode, when the finger touches on the display portion 7028, the control device 708 may select the display portion 7028 to be the specific display portion for scanning the fingerprint of the finger. The control device 708 may generate the control signal ST4 (e.g. 240 Hz) to activate the driving device 7048 to scan the fingerprint by the second frame rate (e.g. 240 fps). Meanwhile, the control device 708 may disable the driving devices 7042, 7044, 7046, and 7050 such that those driving devices do not affect the scanning operation of the driving device 7048, i.e. the control device 708 keeps the voltage levels of the control signals ST1, ST2, ST3, and ST5 to be low voltage level. Therefore, the driving devices 7042, 7044, 7046, and 7050 may stop detect the touch signals on the display portions 7022, 7024, 7026, and 7030 when the driving device 7048 scans the fingerprint on the display portion 7028. The operation and benefit of the second operating mode of the displaying apparatus 700 are similar to the operation and benefit of the second operating mode of the displaying apparatus 400, and the detailed is omitted here for brevity.

According to some embodiments, once the display portion 7028 is selected to be the specific display portion to scan the fingerprint, the displaying apparatus 700 may always use the display portion 7028 to scan the fingerprint during the second operating mode. However, this is not a limitation of the present invention. In another embodiments, the control device 708 may always repeat the above mentioned process of detecting the finger position to select the new display portion to he the specific display portion for scanning the fingerprint during the second operating mode. Accordingly, the position of fingerprint scanning is not fixed on a position of the panel 702.

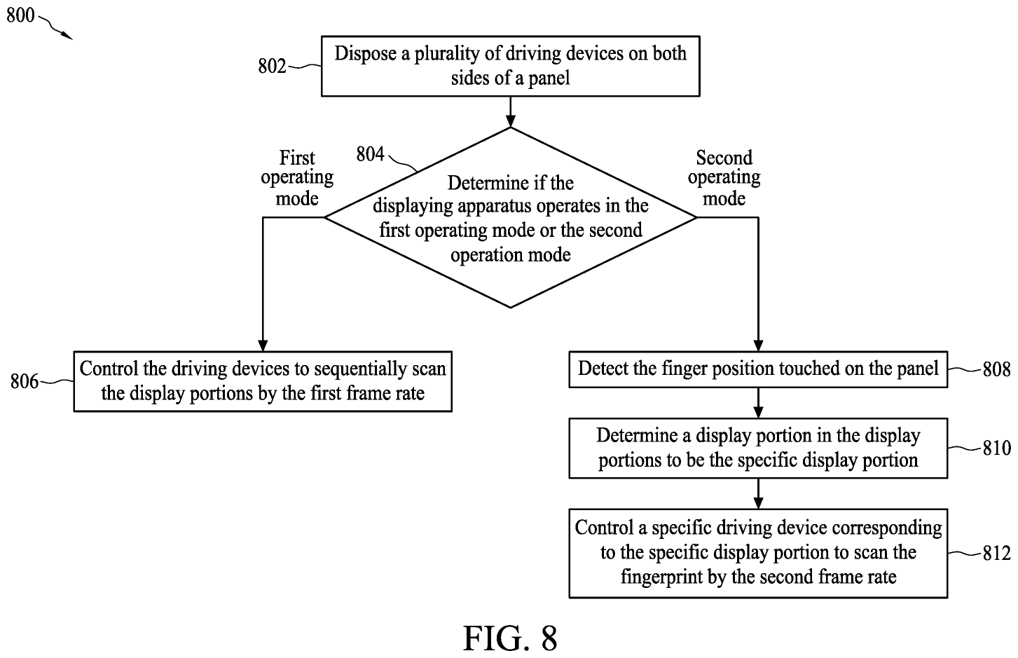

The operation of the displaying apparatus 700 may he summarized into the steps as shown in FIG. 8. FIG. 8 is a flowchart illustrating a method 800 of controlling a displaying apparatus (e.g. 700) in accordance with some embodiments. The method 800 comprises steps 802-812.

In step 802, the plurality of driving devices 7042-7050 are disposed in sequence from the upper of both sides of the panel 702 to the lower of both sides of the panel 702. The driving devices 7042-7050 are arranged to drive the display portions 7022-7030 of the panel 702 respectively.

In step 804, determining if the displaying apparatus 700 operates in the first operating mode or the second operation mode. When the displaying apparatus 700 operates in the first operating mode, the method 800 goes to step 806. When the displaying apparatus 700 operates in the second operating mode, the method 800 goes to step 808.

In step 806, the control device 708 controls the driving devices 7042-7050 to sequentially scan the display portions 7022-4030 by the first frame rate.

In step 808, the control device 708 detects the finger position touched on the panel 802.

In step 810, a display portion in the display portions 7022-7030 is determined to be the specific display portion used to scan the fingerprint.

In step 812, the control device 708 controls a specific driving device corresponding to the specific display portion to scan the fingerprint by the second frame rate higher than the first frame rate. The control device 708 also controls the driving devices other than the specific driving device to stop detect a touch signal on the display portions other than the specific display portion when the specific driving device scans the fingerprint.

Briefly, the present invention provides a displaying apparatus capable of scanning the fingerprint on a touch panel. Moreover, the position of the fingerprint sensor on the panel may be customized by a user.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A displaying apparatus, comprising.
a panel;
a first driving device, disposed on an upper side of the panel, for driving a first display portion of the panel;
a second driving device, disposed on a lower side of the panel, for driving a second display portion of the panel; and
a control device, coupled to the first driving device and the second driving device, for controlling one of the first driving device and the second driving device to scan a fingerprint on one of the first display portion and the second display portion respectively.

2. The displaying apparatus of claim 1, wherein the first display portion and the second display portion are different portions on the panel.

3. The displaying apparatus of claim 1, wherein the first driving device and the second driving device are separated driving devices on the upper side and the lower side of the panel respectively.

4. The displaying apparatus of claim 1, wherein the area of the first display portion is a first area, the area of the second display portion is a second area, and the first area is greater than the second area.

5. The displaying apparatus of claim 1, wherein the first driving device and the second driving device are arranged to scan the first display portion and the second display portion by a first frame rate during a first operating mode of the panel, and the second driving device is arranged to scan the second display portion by a second frame rate during a second operating mode of the panel, and the second frame rate is higher than the first frame rate.

6. The displaying apparatus of claim 5, wherein the first driving device is disabled during the second operating mode.

7. The displaying apparatus of claim 5, wherein the first display portion and the second display portion are arranged to detect a touch signal during the first operating mode, and the second display portion is arranged to detect the fingerprint during the second operating mode.

8. The displaying apparatus of claim 7, wherein the first display portion is arranged to not detect the touch signal during the second operating mode.

9. The displaying apparatus of claim 5, wherein, during the first operating mode, the control device controls the first driving device to scan the first display portion and to control the second driving device to scan the second display portion after the first display portion is scanned.

10. A displaying apparatus, comprising:
a panel;
a plurality of driving devices, disposed in sequence from an upper side of the panel to a lower side of the panel, for driving a plurality of display portions of the panel respectively; and
a control device, coupled to the plurality driving devices, for selecting one of the plurality driving devices to scan a fingerprint on the panel according to a position of the fingerprint.

11. The displaying apparatus of claim 10, wherein the plurality of display portions are different portions on the panel.

12. The displaying apparatus of claim 10, wherein the plurality of driving devices are separated driving devices disposed from the upper side to the lower side of the panel.

13. The displaying apparatus of claim 10, wherein the plurality of display portions are configured to have a same area.

14. The displaying apparatus of claim 10, wherein the control device further determines a specific display portion in the plurality of portions according to a finger position on the panel, and the control device further controls a specific driving device in the plurality of driving devices to scan the fingerprint on the specific display portion, and the specific display portion corresponds to the specific driving device.

15. The displaying apparatus of claim 14, wherein the control device further controls the plurality of display portions other than the specific display portion to stop detect a touch signal when the specific driving device scans the fingerprint on the specific display portion.

16. The displaying apparatus of claim 10, wherein, during a first operating mode, the control circuit controls the plurality of driving devices to sequentially scan the plurality of display portions according to a first frame rate; during a second operating mode, the control circuit controls a specific driving device in the plurality of driving devices to scan the finger print in a specific display portion in the plurality of display portions according to a second frame rate; and the second frame rate is higher than the first frame rate.

17. A method of controlling a displaying apparatus, wherein the displaying apparatus comprises:
a panel, having a plurality of display portions; and
a plurality of driving devices, disposed in sequence from an upper side to a lower side of the panel; and
the method comprises:
determining a specific display portion in the plurality of display portions according to a finger position on the panel; and
controlling a specific driving device in the plurality of driving devices to scan a fingerprint on the specific display portion;
wherein the specific display portion corresponds to the specific driving device.

18. The method of claim 17, further comprising:
detecting the finger position on the panel.

19. The method of claim 17, further comprising:
controlling other driving devices in the plurality of driving devices to stop detect a touch signal on the plurality of display portions other than the specific display portion when the specific driving device scans the fingerprint on the specific display portion.

20. The method of claim 17, further comprising:
during a first operating mode, controlling the plurality of driving devices to sequentially scan the plurality of display portions according to a first frame rate; and
during a second operating mode, controlling the specific driving device in the plurality of driving devices to scan the fingerprint in the specific display portion in the plurality of display portions according to a second frame rate; and the second frame is higher than the first frame rate.
